(19) United States
(12) Patent Application Publication
(10) Pub. No.: US 2005/0094499 A1
(43) Pub. Date: May 5, 2005

(54) Asymmetric run length constraints for increased resolution and power margin in mammos read-out

(76) Inventor: Coen Adrianus Verschuren, Eindhoven (NL)

Correspondence Address: U S Philips Corporation;Intellectual Property Department, P O Box 3001, Briarcliff Manor, NY, 10510, US

(21) Appl. No.: 10/497,430

(22) PCT Filed: Dec. 6, 2002
(86) PCT No.: PCT/IB02/05205

(30) Foreign Application Priority Data
Dec. 7, 2001 (EP) 01204749.4

(51) Int. Cl. G11B 11/00

(52) U.S. Cl. 369/13.01; 369/59.1

(57) ABSTRACT

In the present invention asymmetric run length constraints with different minimum run lengths for first and second patterns representing binary data are introduced, like dm=0 for the first pattenr, i.e. shortest sequence of first patterns is equal to the bit period, and ds>0 for the second pattern, i.e. shortest sequence of second patterns is equal to d+1 bit periods. Thereby, the small “cost” of a reduced code rate will be more than compensated by a large increase in power margin.

The present invention relates to a recording and reading method and apparatus and a recording medium for binary data. In particular, the present invention relates to a recording and reading technique for a domain expansion system, such as a Magnetic AMplifying Magneto-Optical System (MAMMOS), for improving the available readout power margin of the laser and/or the storage density.

In magneto-optical (MO) storage systems, the minimum width of the recorded marks is determined by the diffraction limit, i.e. by the Numerical Aperture (NA) of the focussing lens and the laser wavelength. A reduction of the width is generally based on shorter wavelength lasers and higher NA focussing optics. The higher the NA of a lens the smaller the diameter of light incident or spot on the disk. Blue lasers (approximately 410 nm) will provide a spot incident 37 percent smaller than possible with today's red lasers (approximately 650 nm). This 37 percent smaller spot incident translates to a doubling of area density and a substantial increase in data transfer rate.

During magneto-optical recording, the minimum bit length can be reduced to below the optical diffraction limit by using Laser Pulsed-Magnetic Field Modulation (LP-MFM). In LP-MFM, the bit transitions are determined by the switching of the magnetic field and the temperature gradient induced by the switching of the laser. The quick changes in magnetic field polarity and in temperature gradient produce marks an the disk that are narrow and tall often referred to as crescents. These crescent shaped marks provide a significant increase in bit density, therefore the bit density is no longer limited by wavelength of the laser. By using MFM the limiting factor on bit density shifts from the wavelength of the laser to the ability to resolve individual marks during read-out using a spot that may cover several marks.

For read-out of the small crescent shaped marks, Magnetic Super Resolution (MSR) or Domain Expansion (DomEx) methods have to be used. These technologies are based on recording media with several magneto-static or exchange-coupled Rare-Earth-Transition-Metal layers (RE-TM layers).

According to MSR, a read-out layer on a magneto-optical disk is arranged to mask adjacent bits during reading, while, according to domain expansion, a domain in the centre of a spot is expanded.

While, according to DomEx, instead of masking inside the beam spot, the tiny recording mark in the recording layer is enlarged to read, i.e. a domain in the centre of a spot is expanded. Here, a written mark with upwards magnetization from the storage layer is copied to the read-out layer upon laser heating with the help of an external magnetic field. Due to the low coercivity of this read-out layer the copied mark will expand to fill the optical spot and can be detected optically with a saturated signal level which is independent of the mark size. Reversal of the external magnetic field collapses the expanded domain. A space in the storage layer with downwards magnetization, on the other hand, will not be copied and no expansion occurs. Therefore, no signal will be detected in this case.

The advantage of the DomEx technique over MSR results in that bits with a length below the diffraction limit can be detected with a similar SNR as bits with a size comparable to the diffraction limited spot.

Briefly, MAMMOS is such a DomEx method based on magneto-statically coupled storage and read-out layers, wherein MFM is used for expansion and collapse of expanded domains in the read-out layer. In general terms, MAMMOS is similar to MSR, except that when the data is copied from the bottom to the upper layer, it is expanded in size, amplifying the signal.

The resolution of the MAMMOS read-out process, i.e. the smallest bit size that can be reproduced without interference from neighbouring bits, is limited by the spatial extent of the copy process, i.e. the copy window size, which is determined by the overlap of the temperature induced coercivity profile and the stray field profile of the bit pattern, which profile depends on the strength of the external magnetic field.

Therefore, the laser power that is used in the read-out process should be high enough to enable copying. However, a higher laser power also increases the overlap of the temperature induced coercivity profile and the stray field profile of the bit pattern (coercivity Hc decreases, stray field increases with increasing temperature). When this overlap becomes too large, correct read-out of a space is no longer possible because false signals are generated by neighbouring marks. The difference between this maximum and the minimum laser power determines the power margin, which decreases strongly with decreasing bit length. Experiments show that with the current methods, bit lengths of 0.10 μm can be correctly detected, but at a power margin of virtually nothing, e.g. 1 bit of a 16 bit Digital Analog Converter. Therefore, several read and write strategies have been proposed to improve the resolution and/or the power margin. However, for the highest densities, further improvement is necessary. Unlike e.g. DVR, all MAMMOS signals are saturated (digital). Therefore, detection and correction methods using the signal amplitude of surrounding bits (run length or missed run detector) can not be used for MAMMOS.

Up to now, in MAMMOS read-out, a bit decision must be made at each bit period (due to external field modulation), so that symmetric run length constraints with d=0 and a simple threshold detector for read-out seems logical. Symmetric run length constraints with d=0 mean that the binary data within a recording track of the recording medium demands for the minimum number of adjacent marks or spaces d+1, respectively, i.e. with d=0 the minimum run length of marks or spaces can be one bit period, respectively. However, as aforementioned, read-out of high density bit length can only be detected within a very restricted power margin.

It is therefore an object of the present invention to provide a method, apparatus and medium for recording and reading on a magneto-optical medium, by means of which the available power margin of the laser in MAMMOS reading and/or the storage density can be improved.

This object is achieved by a recording and a reading method as claimed in claim 1 and 3, a recording and a reading apparatus as claimed in claim 18 and 20, and a recording medium as claimed in claim 26. Other advantageous developments are defined in the dependent claims.

Accordingly, a large power margin improvement can be achieved by exploiting the difference in read-out between marks and spaces, since space read-out limits the resolution, the length of a space should be large compared to the mark. Thus, it is beneficial to use asymmetric minimum run length constraints, like
(1) d=0 constraint for marks, i.e. smallest mark is equal to the bit period, and
(2) d>0 constraint for spaces, i.e. smallest space is equal to (d+1) bit periods.

The present invention is used for recording and reading binary data on a recording medium, respectively, the binary data is encoded on the recording medium, represented by first and second patterns, which may have a predetermined duration that corresponds to a predetermined length on the recording medium. Further, a pattern may consist of one predetermined physical status of said recording medium or a combination of a first predetermined physical status and a second predetermined physical status of said recording medium. Further, said recording medium may be a magneto-optical medium and therefore a first physical status of said recording medium is a mark and a second physical status of said recording medium is a space. Moreover, a domain expansion technique for read-out may be used, in particular this may be a MAMMOS technique, wherein an external magnetic reading field is used for recording and read-out.

In a first embodiment of the present invention, asymmetric run lengths for the first and second patterns are used such that said first minimum run length corresponds to a minimum of one first pattern and said second minimum run length corresponds to a minimum of 2n+1 second patterns, wherein n is an integer greater zero. By synchronizing the timing of an external reading field within the duration of a pattern on said recording medium with the centre of the duration of said first predetermined physical status of said recording medium, the data density on the recording medium and/or the read-out of the binary data can be optimized.

In a second embodiment of the present invention asymmetric run lengths for the first and second patterns are used such that said first minimum run length corresponds to a minimum of one first pattern and said second minimum run length corresponds to a minimum of 2n second patterns, wherein n is an integer greater zero. By synchronizing the timing of the external reading field within the duration of a pattern on said recording medium with the centre of the shortest duration of said second predetermined physical status of said recording medium, the data density on the recording medium and/or the read-out of the binary data can be optimized.

In another embodiment of the present invention the values for said first and second minimum run lengths of said first and said second patterns are set at the time of reading of said data stored on said recording medium according to the result of a predetermined test read-out. This test read-out may be reading of a predefined test area on the recording medium and/or a run length violation check in the user data.

Additionally, maximum run length constraints may be used for said first and second patterns. Detection of run length violation of maximum run lengths is useful for determining the copy window range based on the number of additional or missing peaks in the data stream, in the same way as for the minimum run length violations. The advantage of using maximum run lengths is that more information is collected in a shorter time resulting in earlier detection (and determination of window range, etc.).

These and other aspects of the invention will be apparent from and elucidated with reference to the embodiments described hereinafter with reference to the accompanying drawing figures, in which:

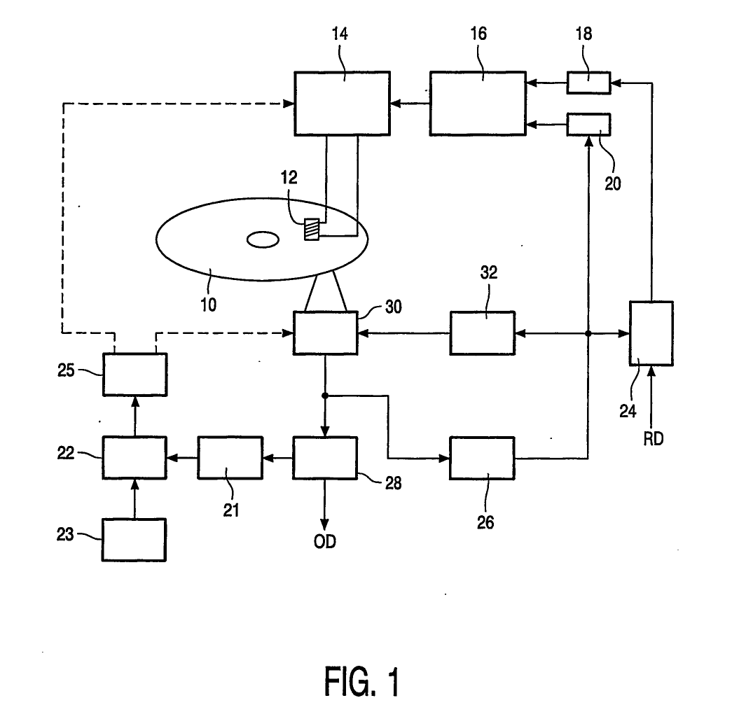

FIG. 1 shows a schematic diagram of a magneto-optical disk player, according to the preferred embodiment;

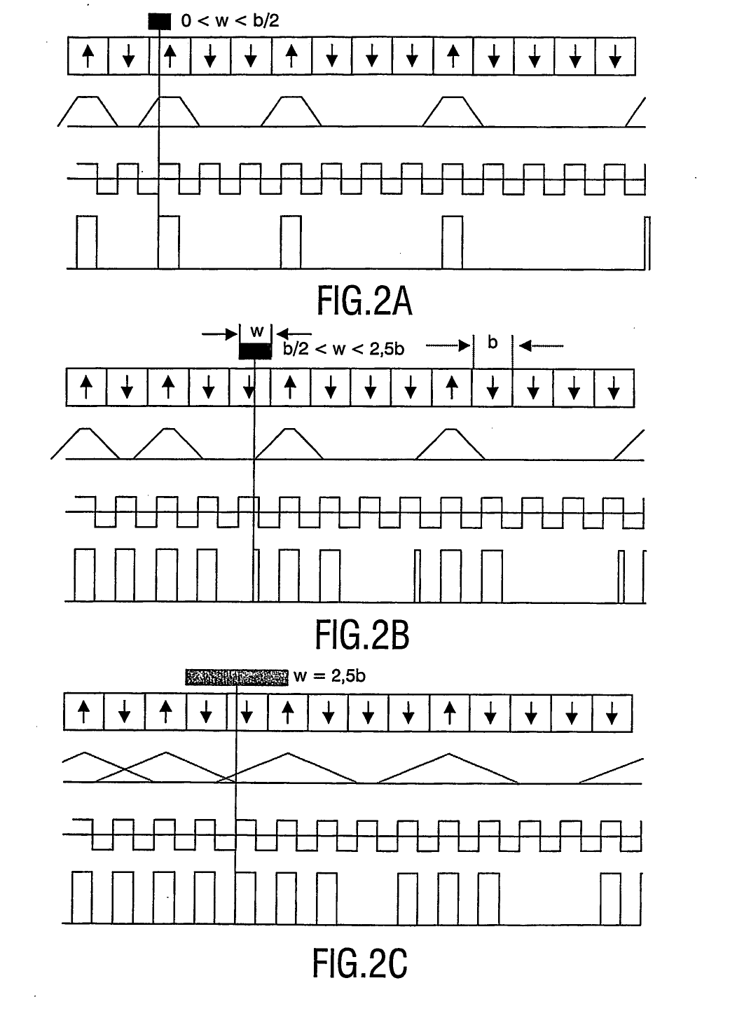

FIG. 2A to 2C show signaling diagrams of conventional MAMMOS read-out strategy for three different copy window sizes;

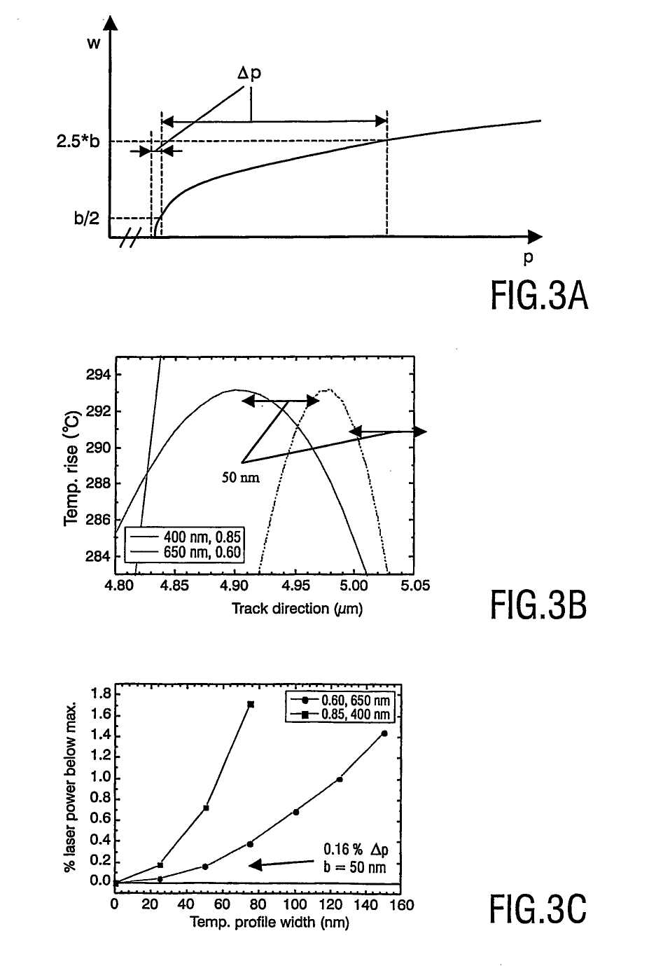

FIG. 3A shows qualitatively the relation between the laser power and the copy window size;

FIG. 3B shows the width of the thermal profile induced by the laser spot, which determines the copy window size;

FIG. 3C shows the allowed variation in laser power to yield a certain thermal profile width;

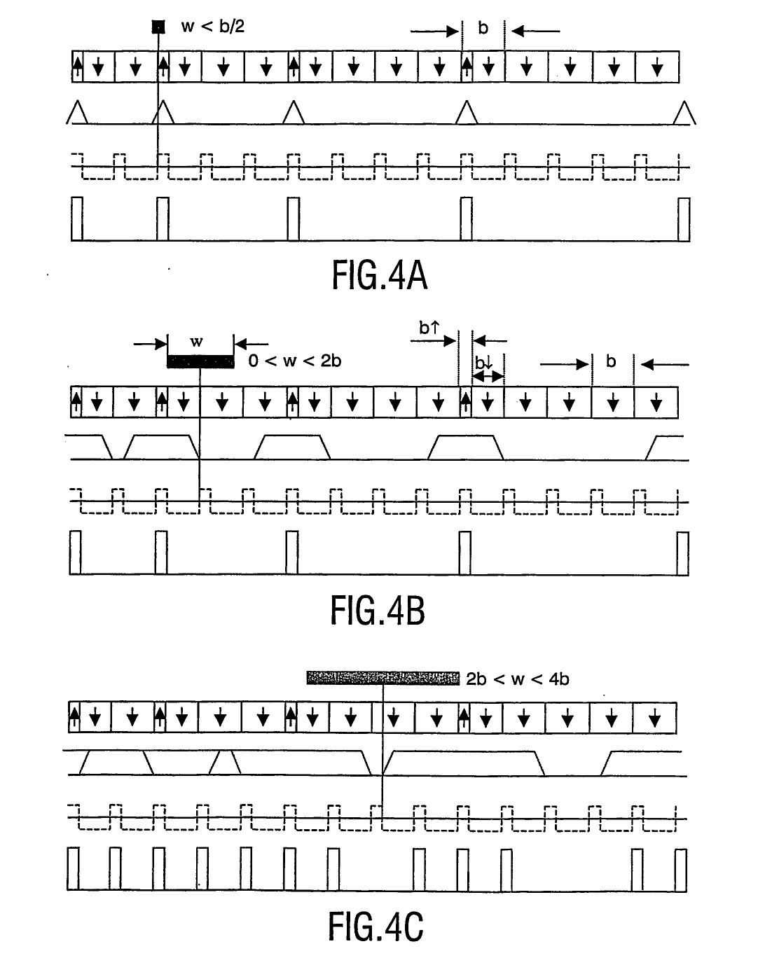

FIG. 4A to 4C show signaling diagrams of MAMMOS read-out strategy for three different copy window sizes and a short duration of the external magnetic field in the expansion direction, wherein the expansion takes place when the copy window is centred on mark;

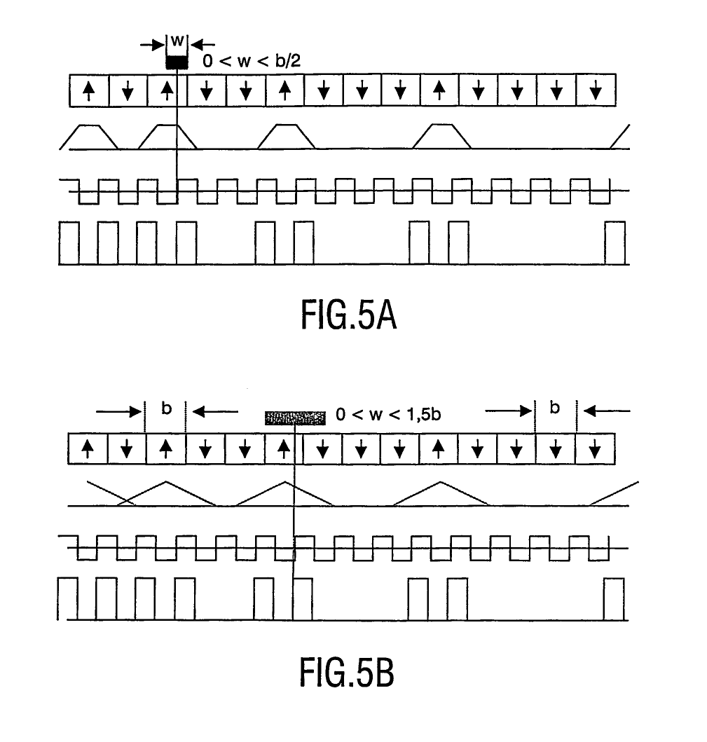

FIG. 5A, 5B show signaling diagrams of conventional MAMMOS read-out strategy for two different copy window sizes, wherein the expansion takes place when the copy window is centred on −I2 space region; and

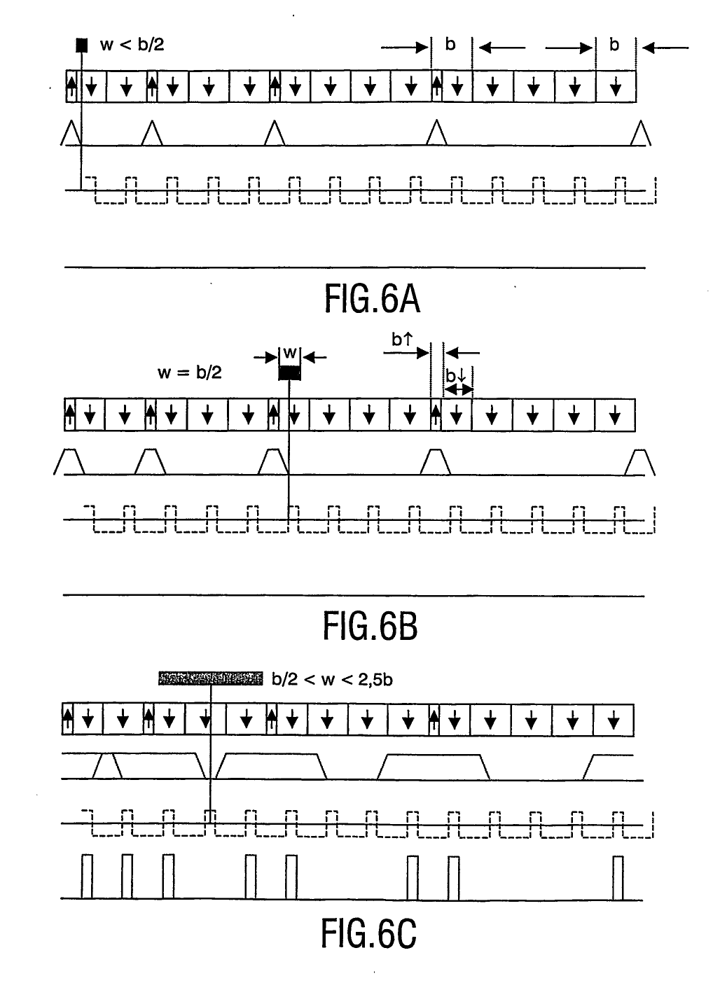

FIG. 6A to 6C show signaling diagrams of MAMMOS read-out strategy for three different copy window sizes and short duration of the external magnetic field in the expansion direction, wherein the expansion takes place when the copy window is centred on −I2 space region;

The preferred embodiments will now be described on the basis of a MAMMOS disk player as indicated in FIG. 1, which schematically shows the construction of the disk player according to the preferred embodiments. The disk player comprises an optical pick-up unit 30 having a laser light radiating section for irradiation of a magneto-optical recording medium or record carrier 10, such as a magneto-optical disk, with light that has been converted, during recording, to pulses with a period synchronized with binary data and a magnetic field applying section comprising a magnetic head 12 which applies a magnetic field in a controlled manner at the time of recording and playback on the magneto-optical disk 10. In the optical pick-up unit 30 a laser is connected to a laser driving circuit which receives recording and read-out pulses from a recording/read-out pulse adjusting unit 32 to thereby control the pulse amplitude and timing of the laser of the optical pick-up unit 30 during a recording and read-out operation. The recording/read-out pulse adjusting circuit 32 receives a clock signal from a clock generator 26 which may comprise a PLL (Phase Locked Loop) circuit.

It is noted that, for reasons of simplicity, the magnetic head 12 and the optical pickup unit 30 are shown on opposite sides of the disk 10 in FIG. 1. However, according to the preferred embodiment, they should be arranged on the same side of the disk 10.

The magnetic head 12 is connected to a head driver unit 14 and receives, at the time of recording, code-converted binary data via a phase adjusting circuit 18 from a modulator 24. Therefore, the modulator 24 converts input recording data RD according to one of the aspects of the present invention.

At the time of playback, the head driver 14 receives a clock signal via a playback adjusting circuit 20 from the clock generator 26, wherein the playback adjusting circuit 20 generates a synchronization signal for adjusting the timing and amplitude of pulses applied to the magnetic head 12. A recording/playback switch 16 is provided for switching or selecting the respective signal to be supplied to the head driver 14 at the time of recording and at the time of playback.

Furthermore, the optical pick-up unit 30 comprises a detector for detecting laser light reflected from the disk 10 and for generating a corresponding reading signal applied to a decoder 28 which is arranged to convert reading data according to one of the aspects of the present invention to generate output data OD. Furthermore, the reading signal generated by the optical pick-up unit 30 is supplied to a clock generator 26 in which a clock signal obtained from embossed clock marks of the disk 10 is extracted, and which supplies the clock signal for synchronization purposes to the recording pulse adjusting circuit 32, the playback adjusting circuit 20, and the modulator 24. In particular, a data channel clock may be generated in the PLL circuit of the clock generator 26.

In case of data recording, the laser of the optical pick-up unit 30 is modulated with a fixed frequency corresponding to the period of the data channel clock, and the data recording area or spot of the rotating disk 10 is locally heated at equal distances. Additionally, the data channel clock output by the clock generator 26 controls the modulator 24 to generate a data signal with the standard clock period. The input recording data RD are modulated and converted by the modulator 24 according to one of the aspects of the present invention to obtain a binary run length information corresponding to the information of the recording data RD.

The structure of the magneto-optical recording medium 10 may correspond to the structure described in the JP-A-2000-260079.

The playback adjusting circuit 20 can be arranged to set the duty cycle of the signal supplied via the head driver 14 to the coil of the magnetic head 12, so as to provide the needed duration of the expansion direction of the external magnetic field. Thus, the time fraction for expansion may be reduced to a minimum allowable value to thereby allow smallest channel bit length and thus a maximum recording density. On the other hand, in case of longer channel bit lengths, the minimum time fraction for expansion allows high flexibility in the applicable copy window size to thereby optimize the power margin.

The occurrence of false signals due to a large overlap, e.g. laser power too high, should normally in conventional MAMMOS read-out be avoided. However, if the data structure on the recording medium is according to one of the aspects of the present invention such that the occurrence and number of false peaks gives a direct and predetermined information on the data stored in the storage layer, then this information can be used to retrieve correctly the previous and/or following data on the disk 10.

FIG. 2A-2C show signaling diagrams for an example of a disk 10. Binary data is recorded with a first and a second pattern respectively consisting of at least one of a first and a second physical status of the recording medium. The first physical status of the recording medium is a mark and the second physical status of the recording medium is a space. A mark is an upward magnetization, indicated by an upward arrow, and a space is a downward magnetization, also indicated by a downward arrow.

The recording track of the disk 10 has a range of space run lengths (−I1, −I2, −I3, −I4), separated by I1 marks, as indicated in the upper line. It should be noted that the description for reading the diagrams of FIG. 2A-2C can be applied for the FIG. 4A-6C, respectively. The expression “-In” denotes a space run length with a duration corresponding to n channel bits (minimum space or mark regions), while the expression “In” denotes a mark run length with a duration corresponding to n channel bits, e.g. I2 referrers to a run length of n=2 subsequent marks, while −I3 referrers to a run length of n=3 subsequent spaces. The resulting time dependency of the overlaps (second line from above in the FIG. 2A-2C) upon read-out with different copy window sizes w FIG. 2A, FIG. 2B and FIG. 2C are indicated, as well as the MAMMOS signals or peaks (fourth line in the FIG. 2A-2C) generated with the external magnetic field (third line in the FIG. 2A-2C).

For a conventional, correct read-out, the copy window size has to be smaller than half the channel bit length b (as applies for the copy window size w<b/2 in FIG. 2A). In this case, each mark bit will yield one MAMMOS peak and no peaks are generated for space bits. Thus, detection of n subsequent peaks indicates an In mark run length, whereas n missing peaks indicate a −In space run length. This situation is indicated in FIG. 2A. For larger window sizes, e.g. b/2<w<2,5b, additional MAMMOS peaks will be generated for space regions in front and behind a mark region due to the larger overlap (FIG. 2B). For example, an I1 mark will now yield 3 peaks instead of 1. Obviously, −I4 and −I2 spaces can no longer be detected now. A −I3 space will show 1 missing peak instead of 3 missing peaks. Even larger window sizes, up to e.g. w=2,5b (FIG. 2C), cause the same difference of 2 peaks in space and mark run length detection. The timing of the external magnetic field in conventional read-out is obviously synchronized both to the center of each mark and each space.

The effects of different copy window sizes w on the number of peaks or missing peaks, which can be detected at predetermined run lengths can be summarized as follows:
(1) If the window size w is smaller than half of the channel bit length b, the number of detected peaks and missing peaks of the read-out data corresponds to the run lengths of the recorded information.
(2) If the copy window size w is in the range between b/2 and 2.5b, the number of detected peaks equals to the recorded mark run length plus two peaks and the number of missing peaks equals to the recorded space run length minus two peaks (provided that the run length is three or more).

These results can be used as demands on a recording and corresponding reading method that is employed for defining and interpreting the data structure on the disk 10. Since the copy window size w increases with increasing laser power p (as well as ambient temperature and external magnetic field), it would be also possible to do power and/or field control during read-out, e.g. by detection of run length violations in the read user data and/or by using a test area with pre-defined mark and space run lengths. Especially, the first option is attractive since much less or no disk capacity has to be reserved for power calibration, as the user data is used for this purpose. Moreover, when the data structure, i.e. the used run length constraints, on the recording medium has been detected, the laser power p can be controlled to stay within the power range for effecting the applicable copy window size w. Thus, missing and additional peaks in the data stream can be translated into correct run length data by using the information of the employed reading method, which may be implemented in the decoding unit 24.

The run length violations may be determined by an analyzing unit 21, e.g. based on a determination of the peak numbers in the read-out signal by a pulse counting function or based on a measurement of the space periods in the read-out signal by a timer function.

Known in the art of MAMMOS read-out is to make a bit decision at each bit period (due to external field modulation), so that in conventional instances read-out of symmetric run lengths d=dm=ds=0 with a simple threshold detector seems logical, wherein m in dm denotes a mark and s in ds a space. However, a large power margin Δp improvement can be achieved by exploiting the difference in read-out between marks and spaces. As learned above, space read-out limits the resolution, thus the length of a space should be large compared to the mark. Therefore, it is beneficial to use different run length constraints for marks and spaces, i.e. asymmetric run length constraints, as follows:
(1) a dm=0 constraint for marks, i.e. smallest mark is equal to the bit period, and
(2) a ds>0 constraint for spaces, i.e. smallest space is equal to ds+1 bit periods.

In a first aspect of the present invention asymmetric constraints are introduced wherein dm is set to 0 for marks and ds is set to 2k for spaces, wherein k is an integer greater zero. Thus, ds is an even integer. For the following an example is given, wherein k is set to 1 and thus ds equals 2. Read-out of such run length coded information is not trivial, as can be seen in FIG. 2A-2C. For windows smaller than b/2 (FIG. 2A) normal read-out without errors is possible, i.e. one MAMMOS peak per mark period, no peak for any space period. For larger windows (FIG. 2B) extra peaks appear at the first and the last space period. As can be seen, −I1 and −I2 spaces can not be detected and only a −I3 space shows one missing peak instead of three. This situation remains the same for increasing windows, up to w=2.5b (FIG. 2C). More generally, for this window range (b/2<w<2.5b) a mark run length In will show n+2 peaks, whereas a space run length In will yield n−2 missing peaks.

By applying a slightly modified detection scheme according to a dm=0 run length constraint for marks and a ds=2 run length constraint for spaces, it is possible to use the much larger window range of b/2<w<2.5*b instead of 0<w<b/2. This means that the power margin Δp for read-out increases very much, as schematically illustrated in FIG. 3A wherein the copy window size w over laser power p is shown. The relation in FIG. 3A can be understood qualitatively by realizing that the copy window size is directly related to the width of the thermal profile induced by the laser spot, which is plotted in FIG. 3B. In FIG. 3C the allowed variation in laser power p for a certain profile width is illustrated, i.e. the power margin Δp increases strongly for larger widths.

Moreover, this increase in power margin Δp more than compensates for the somewhat reduced storage capacity and code rate due to e.g. (0,7)/(2,7) instead of (0,7) modulation. A (0,7) modulation denotes that symmetric run length constraints are employed and the smallest run length for marks and spaces are I1 and −I1 (dm=ds=0), respectively, while the largest run length for marks and space regions are I7 and −I7, respectively. While, a (0,7)/(2,7) modulation in the way of one of the aspects of the present invention means that asymmetric run length constraints are employed, in which for marks the shortest run length is I1 (dm=0) and the largest run length is I7, while for spaces the shortest run length is −I3 (ds=2) and the longest run length is −I7, respectively. Therefore, asymmetric run length constraints are used with dm=0 and ds=2. Thus, if the smallest mark run length in a data sequence observed by the analyzing unit 21 is larger than 1 (e.g. 3 subsequent peaks), a comparing unit 22 determines a correction of 2 peaks (for all previous data) and thus an applicable range for the copy window size w between b/2 and 2.5b. The information of the applicable range for the copy window size w may be stored in a LUT (look up table) unit 23.

For channel bit length b=100 nm and a symmetric (0,7) modulation, 0<w<b/2=50 nm yields a power margin of only 0.7% for red DVD recorder conditions (633 nm, NA=0.60). Using an asymmetric (0,7)/(2,7) modulation, allows window width within the range 50 nm<w<250 nm and gives a power margin Δp as large as 7%, but at an estimated density of 75%. For channel bit length b=50 nm, a power margin Δp of 3.3% follows for a (0,7)/(2,7) modulation, with a density of 150%, i.e. 1.5 times more density at a 5 times larger power margin Δp for the same conditions. For comparison, an optimal write and read strategy with (0,7) modulation achieves 100% density at the same power margin Δp of 3.3%.

FIG. 4A-4C show a combination of a (0,7)/(2,7) modulation with a write and read strategy, wherein the duration of the expansion direction of the external magnetic field is adjusted to be as small as possible and a bit region with a mark corresponds to a pattern comprising a small sub-mark region b↑ and a subsequent larger non-mark region b↓, i.e. b↑+b↓=b. The timing of the external magnetic field is when the read-out window is centred on said sub-mark. Hereby a density of about 188% at a power margin Δp of 3.5% can be achieved.

In the more general case
(1) the conventional (0,7) modulation region requires 0<w<2b−b↑−exp,
(2) while the (0,7)/(2,7) region allows 2b−b↑−exp<w<4b−b↑−exp.
   wherein exp corresponds to the expansion duration multiplied by disk velocity to obtain a corresponding length.

A combination with pulsed laser read-out gives similar results, but without additional requirements on the bandwidth of the external field coil and driver.

Since the number of missing peaks and additional peaks differs by two for these regions, a test area on the disk with a series of pre-defined run lengths (e.g. in the header) and/or a run length violation in the user data may be used to distinguish between them. This may require somewhat more complicated detection procedures, but further increases the power margin, since both regions are now allowed.

In a second aspect of the present invention dm is set to 0 for marks and ds is set to 2k−1 for spaces, wherein k is an integer greater zero. Thus, ds is an odd integer. For the following an example is given, wherein k is set to 1 and thus ds equals 1. As is evident from FIG. 2A-2C, read-out of a dm=0 and ds=1 modulation requires a modification of the timing of the external field, otherwise a −I2 space can not be detected. As can be seen from FIG. 5A-5B the optimum timing is to centre the window (coupled to the optical spot) on the −I2 space area, and in the write strategy of FIG. 6A-6C, including the space part of a mark channel bit. For the situation in FIG. 5A-5B this timing gives one additional peak for a mark run length (In:=n+1 peaks), and reduces the number of missing peaks by one for a space run length (−In:=n−1 missing peaks). This is valid for copy window sizes smaller than 1.51b.

Including the write and read strategies, as illustrated in FIG. 4A-4C, results in FIG. 6A-6C. The maximum copy window size increases to 3b−b↑−exp, but due to the timing of the external magnetic field, no marks will be detected for copy window sizes smaller than b/2. Thus, the total window range is smaller than for the (0,7)/(2,7) modulation, but the code rate for the (0,7)/(1,7) modulation is more efficient. Therefore, the resulting power margin Δp for the same storage density will be comparable to the (0,7)/(2,7) modulation case.

It is noted that pulsed read-out is also compatible with this idea. Which of these modulations is better depends on the actual code rates and the dependence of the copy window size on the laser power.

The present invention shows that a large improvement in resolution and/or power margin Δp can be achieved by using modulations with asymmetrical run length constraints for marks dm and spaces ds. It is noted that (dm=0; ds>2) modulations are also possible. These will further increase the power margin, however at the expense of reduced storage capacity due to lower code rates. Modulations with even ds for spaces will be similar to the presented (dm=0; ds=2) modulation, whereas modulations with odd ds for spaces are similar to the (dm=0; ds=1) modulation. In general the upper limit for the copy window size w will increase by the channel bit length b for each increase of d by 1.

It should be noted that also maximum run length constraints may be used for the marks and spaces. The detection of run length violation of maximum run lengths is useful for determining the copy window range based on the number of additional or missing peaks in the data stream, in the same way as for the minimum run length violations, as described above. The advantage of using maximum run lengths is in read-out because more information is collected in a shorter time resulting in earlier detection and determination of window range, etc.

For high density storage, the power margin Δp is very small in MAMMOS read-out. Therefore, several write and read strategies have been introduced to improve this power margin. However, for the highest densities, the present invention can be used to improve such Magneto-Optical disk storage systems. Unlike e.g. DVR, all MAMMOS signals are saturated, i.e. digital. Thus, detection and correction methods using the signal amplitude of surrounding bits, e.g. run length or missed run length detector, can not be used for MAMMOS. In the present invention asymmetric minimum run length constraints have been introduced, like dm=0 code for marks, i.e. smallest mark is equal to the bit period, and ds>0 code for spaces, i.e. smallest space is equal to d+1 bit periods. Also use of maximum run length constraints for marks and spaces is possible and advantageous. It has been shown that the small “cost” of a reduced code rate is more than compensated by the large increase in the power margin. Because a bit decision must be made at each bit period due to external field modulation, implementation is not trivial and a slight modification of the detection scheme is necessary.

1. A method of recording binary data with first and second patterns on a recording medium, wherein different first and second minimum run lengths are set for the respective patterns.

2. A method according to claim 1, wherein additionally maximum run length constraints are set for said first and said second pattern.

3. A method of reading a binary data with first and second patterns provided on a recording medium, wherein different first and second minimum run lengths of the respective patterns are determined based on said reading.

4. A method according to claim 3, wherein additionally maximum run length constraints are determined for said first and said second pattern.

5. A method according to claim 1, wherein a pattern has a predetermined duration.

6. A method according to claim 1, wherein a pattern consists of one predetermined physical status of said recording medium or a combination of a first predetermined physical status and a second predetermined physical status of said recording medium.

7. A method according to claim 5, wherein said first minimum run length corresponds to a minimum of one first pattern and said second minimum run length corresponds to a minimum of 2n+1 second patterns, wherein n is an integer greater zero.

8. A method according to claim 7, wherein the timing of an external reading field is synchronized with the centre of the shortest duration of said first predetermined physical status of said recording medium.

9. A method according to claim 5, wherein said first minimum run length corresponds to a minimum of one first pattern and said second minimum run length corresponds to a minimum of 2n second patterns, wherein n is an integer greater zero.

10. A method according to claim 9, wherein the timing of an external reading field is synchronized with the centre of the shortest duration of said second predetermined physical status of said recording medium.

11. A method according to claim 3, wherein the values for said first and second minimum run lengths of said first and said second pattern are set at the time of reading of said data stored on said recording medium according to the result of a predetermined test read-out.

12. A method according to claim 11, wherein said test read-out is reading of a predefined test area on the recording medium and/or a run length violation check in the user data.

13. A method according to claim 6, wherein said first physical status of said recording medium is a mark and said second physical status of said recording medium is a space.

14. A method according to claim 1, wherein said recording medium is a magneto-optical medium.

15. A method according claim 14, wherein for read-out a domain expansion technique is used.

16. A method according claim 15, wherein said domain expansion technique is a MAMMOS technique.

17. A method according claim 8, wherein said external reading field is a magnetic field.

18. An apparatus for recording binary data with first and second patterns on a recording medium, said apparatus comprising:
encoding means for encoding said data using asymmetrical minimum run length constraints for the respective patterns of said encoded binary data.

19. An apparatus according to claim 18, wherein additionally maximum run length constraints are used for said first and said second pattern.

20. An apparatus for reading binary data as first and second patterns provided on a recording medium, said apparatus comprising: decoding means for decoding said data, wherein different first and second minimum run lengths of the respective patterns are determined based on said reading.

21. An apparatus according to claim 20, wherein additionally maximum run length constraints are determined for said first and said second pattern.

22. An apparatus according to claim 18, wherein a pattern consists of one predetermined physical status of said recording medium or a combination of a first predetermined physical status and a second predetermined physical status of said recording medium.

23. An apparatus according to claim 22, wherein said first physical status of said recording medium is a mark and said second physical status of said recording medium is a space.

24. An apparatus according to claim 18, wherein said apparatus is a disk player for a magneto-optical disk to be read by a domain expansion technique.

25. An apparatus according to claim 24, wherein said domain expansion technique is a MAMMOS technique.

26. A recording medium on which binary data is recorded on a recording track with first and second patterns, wherein said binary data is recorded with asymmetrical minimum run length for the respective first and second patterns.

27. A recording medium according to claim 26, wherein additionally maximum run length constraints are used for said first and said second pattern.

28. A recording medium according to claim 26, wherein a pattern consists of one predetermined physical status of said recording medium or a combination of a first predetermined physical status and a second predetermined physical status of said recording medium.

29. A recording medium according to claim 26, wherein said first minimum run length corresponds to a minimum of one first pattern and said second minimum run length corresponds to a minimum of 2n+1 second patterns, wherein n is an integer greater zero.

30. A recording medium according to claim 26, wherein said first minimum run length corresponds to a minimum of one first pattern and said second minimum run length corresponds to a minimum of 2n second patterns, wherein n is an integer greater zero.

31. A recording medium according to claim 26, wherein said recording medium is a magneto-optical disk.

32. A recording medium according to claim 31, wherein said magneto-optical disk is a MAMMOS disk.
